(19) United States
(12) Patent Application Publication
(10) Pub. No.: US 2025/0172911 A1
(43) Pub. Date: May 29, 2025

(54) DISPLAY DEVICE COMPRISING A MECHANISM FOR COUPLING TO A WATCH MOVEMENT

(71) Applicant: Montres Breguet S.A., L'Abbaye (CH)

(72) Inventors: Jérôme MACE, Le Pont (CH); Quentin THEURILLAT-BONJOUR, Vallorbe (CH)

(73) Assignee: Montres Breguet S.A., L'Abbaye (CH)

(21) Appl. No.: 18/904,714

(22) Filed: Oct. 2, 2024

(30) Foreign Application Priority Data
Nov. 23, 2023 (EP) 23211817.4

(51) Int. Cl. G04B 19/21; G04B 13/00

(52) U.S. Cl. CPC G04B 19/21; G04B 13/00

(57) ABSTRACT

A display device (10) for a watch movement, including: a display (11) intended to be mounted movable relative to a structure (12) of the watch movement and provided with a member (110) for indexing relative to said structure (12), and with a driven wheel (111) whose rotation causes movement of the display (11); a drive mechanism (20) including a driving wheel (21) intended to drive the driven wheel (111) in rotation; and a coupling mechanism (30) including a transmission wheel (31) meshing with the driving wheel (21) and the driven wheel (111), the coupling mechanism (30) being configured so that the centre of rotation of the transmission wheel (31) has a degree of mobility relative to the driving (21) and driven (111) wheels.

### CROSS REFERENCE TO RELATED APPLICATIONS

This application is claiming priority based on Japanese European Application No. 23211817.4 filed on Nov. 23, 2023.

### TECHNICAL FIELD OF THE INVENTION

The invention relates to the field of watchmaking and in particular to watch movements. The invention relates in particular to a display device comprising a mechanism for coupling to a watch movement.

### TECHNOLOGICAL BACKGROUND

In a watch display mechanism for a watch movement, the relative positioning of a display in relation to a reference point such as another display, an aperture or another fixed structure, is particularly important as it is a visible element. The problem of relative positioning of displays is always tricky to solve, as any misalignment, however slight, is highly visible to the user. As the correct positioning of a display is an important guarantee of quality, the incorrect positioning of a display can be very detrimental to the image of a watch brand.

Displays must therefore be indexed very accurately in relation to a given reference point, generally formed by a structure of the watch movement or by another display. However, this indexing can cause difficulties in integrating the display within the kinematic chain of the watch movement, during assembly of the watch movement, in particular at the interface with a drive mechanism intended to transmit the energy of the watch movement to the display.

More specifically, because of machining tolerances, it might be tricky to obtain indexing that meets the required aesthetic quality criteria.

An objective of the present invention is to overcome this drawback by enabling a display to be simply indexed to a drive mechanism of a watch movement.

### SUMMARY OF THE INVENTION

The invention resolves the aforementioned drawbacks and to this end relates to a display device for a watch movement comprising:
a display intended to be mounted movable relative to a structure of the watch movement and provided with a member for indexing relative to said structure, and with a driven wheel whose rotation causes movement of the display;
a drive mechanism comprising a driving wheel intended to drive the driven wheel in rotation;
a coupling mechanism comprising a transmission wheel meshing with the driving wheel and the driven wheel, said coupling mechanism being configured so that the centre of rotation of the transmission wheel has a degree of mobility relative to the driving and driven wheels.

In particular embodiments, the invention may further include one or more of the following features, considered separately or according to any technically possible combination.

In particular embodiments, the coupling mechanism includes a support on which the transmission wheel is rotatably fastened, the support being configured to be in a state in which it is movable in rotation about the axis of rotation of the driving wheel and a stationary state in which it is held in position by a blocking member.

In particular embodiments, the transmission wheel forms a satellite of the driven wheel and the driving wheel is formed by a ring gear including an internal toothing.

In particular embodiments, the driving wheel and the driven wheel are arranged coaxially.

In particular embodiments, the support has two radial arms, one of which carries the transmission wheel and the other of which is held by clamping in a notch in the structure of the watch movement by the blocking member when the support is in the stationary state.

In particular embodiments, one of the arms comprises an adjustment member, the actuation of which allows moving the support when it is in the movable state.

In particular embodiments, the free end of the arm carrying the transmission mobile has the adjustment member. The latter is preferably formed by a notch.

In particular embodiments, the display includes a roller movable in rotation and formed by two lateral flanges between which are interposed flaps movable in rotation respectively according to axes parallel to that of the roller, one of the flanges being kinematically linked to the driven wheel, the axis of rotation of the driving and driven wheels coinciding with that of the roller.

According to another object, the present invention also relates to a watch movement comprising a structure and a display device as described before.

### BRIEF DESCRIPTION OF THE FIGURES

Other features and advantages of the invention will become apparent upon reading the following detailed description, given as a non-limiting example, with reference to the appended drawings wherein:

FIGS. 1 and 2 show exploded perspective views of a display device for a watch movement according to a preferred embodiment of the invention;

FIG. 3 shows a perspective view of the device of FIG. 1.

It should be noted that the figures are not necessarily drawn to scale for clarity.

### DETAILED DESCRIPTION OF THE INVENTION

The invention relates to a display device 10 for a watch movement, comprising a display 11 intended to be mounted movable relative to a structure 12 of the watch movement, such as a plate or a bridge, and a drive mechanism 20 intended to receive the energy from a driving member of the movement in order to move the display 11. The display device 10 also includes a coupling mechanism 30 configured to kinematically connect the display 11 with the drive mechanism 20.

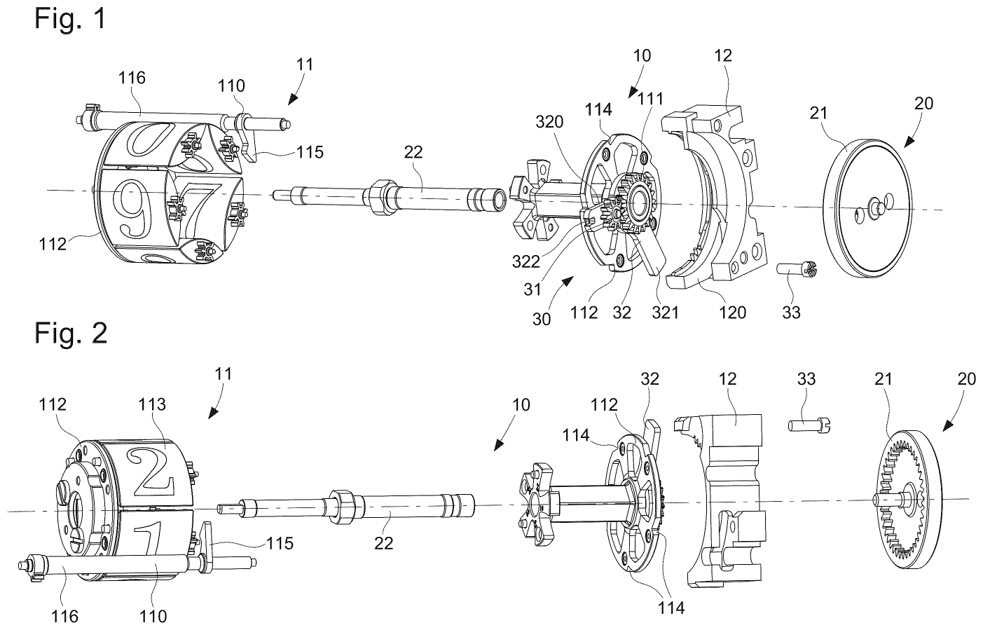

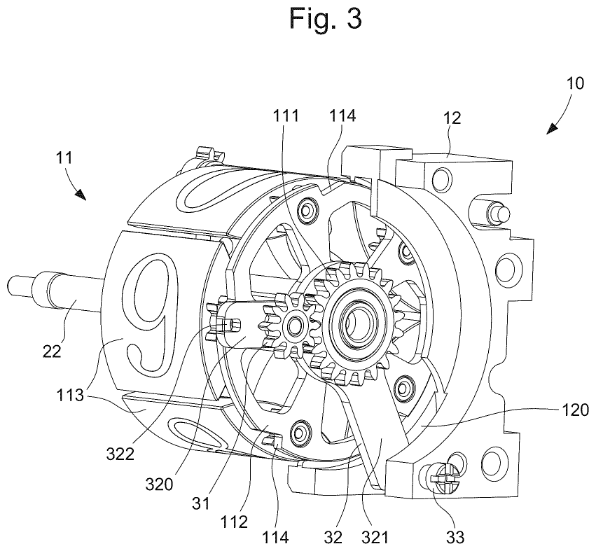

As shown in the exploded views of FIGS. 1 to 3, the display 11 comprises an indexing member 110 imposing an accurate orientation of the display 11 relative to the structure 12. The display 11 also includes a driven wheel 111 whose rotation causes movement of the display 11. The driven wheel 111 is intended to be driven in rotation by the drive mechanism 20, and in particular by a driving wheel 21 of the latter, via a transmission wheel 31 of the coupling mechanism 30.

The coupling mechanism 30 is advantageously configured so that the centre of rotation of the transmission wheel 31 has a degree of mobility relative to the driving 21 and driven 111 wheels.

Advantageously, this feature allows adjusting the position of the transmission wheel 31 relative to the driving 21 and driven 111 wheels so as to enable a correct indexing of the display element.

In the preferred embodiment of the present invention shown in FIGS. 1 to 3, the display 11 includes a roller formed by two lateral flanges 112 mounted movable in rotation on a driving shaft 22 and between which are interposed flaps 113 movable in rotation respectively according to axes parallel to that of the flanges 112. Such a roller is, for example, as described in the patent EP3627240.

As shown in FIGS. 1 to 3, the driven wheel 111 is arranged on the driving shaft 22 so as to rotate freely and is kinematically linked to one of the flanges 112, so that rotation of the driven wheel 111 causes rotation of the flange 112, and therefore of the roller. In particular, the driven wheel 111 is fastened without any degree of freedom to said flange 112.

The indexing member 110 cooperates with the periphery of one of the flanges 112 in order to index the position of the display 11. In particular, in the preferred embodiment of the invention, said flange 112 includes a plurality of radial notches 114 each corresponding to a position of the display 11. The indexing member 110 includes a finger 115 configured so as to adopt an indexing position in which it is engaged with a notch 114 of the flange 112 and a setback position in which it is disengaged from the notch 114. The finger 115 is driven between the indexing and setback positions by a control shaft 116 on which it is fixed, which is moved according to a predetermined frequency, for example once a day if the display 11 is a date display.

Alternatively, the indexing member 110 can index the display 11 passively, for example by elastic deformation, like a neck chain.

The driving wheel 21 is driven in rotation by the driving shaft 22 to which it is fastened without any degree of freedom. Preferably, the driving wheel 21 is formed by a ring gear including an internal toothing connected to a felloe, as shown in FIG. 1. Thus, the driving wheel 21 and the driven wheel 111 are coaxial and their axes of rotation coincide.

In this configuration, the transmission wheel 31 forms a satellite of the driven wheel 111, which forms a sun wheel.

As illustrated in FIGS. 1 to 3, the coupling mechanism 30 includes a support 32 on which the driving wheel 31 is rotatably fastened. Advantageously, the support 32 is configured to be in a state in which it is movable in rotation about the axis of rotation of the driving wheel 21 and a stationary state in which it is intended to be held in position relative to the structure 12 by a blocking member 33.

In particular, the support 32 has two radial arms, a first arm 320 of which carries the transmission wheel 31 and a second arm 321 of which is intended to be held by clamping in a notch 120 in the structure 12 by the blocking member 33 when the support 32 is in the stationary state. Such a blocking member 33 may advantageously be a screw designed to be engaged in the structure 12 according to a helical connection, as illustrated in the figures. Thus, once it has been properly oriented, i.e. so that the transmission wheel 31 meshes with the driving 21 and driven 111 wheels, the support 32 may be clamped against the structure 12 by the screw.

The orientation of the support 32 may be done by handling an adjustment member 322 of the support 32, formed, in the preferred embodiment of the invention, by a free end of the first arm 320. More specifically, the adjustment member 322 of the support 32 may be formed by a notch intended to receive a blade of a tool, for example a screwdriver.

More generally, it should be noted that the modes of implementation and embodiments considered hereinabove have been described as non-limiting examples, and that other variants are consequently conceivable.

1. A display device (10) for a watch movement, comprising:
a display (11) intended to be mounted movable relative to a structure (12) of the watch movement and provided with a member (110) for indexing relative to said structure (12), and with a driven wheel (111) whose rotation causes movement of the display (11);
a drive mechanism (20) comprising a driving wheel (21) intended to drive the driven wheel (111) in rotation; and
a coupling mechanism (30) comprising a transmission wheel (31) meshing with the driving wheel (21) and the driven wheel (111), said coupling mechanism (30) being configured so that the centre of rotation of the transmission wheel (31) has a degree of mobility relative to the driving (21) and driven (111) wheels.

2. The display device (10) according to claim 1, wherein the coupling mechanism (30) includes a support (32) on which the transmission wheel (31) is fastened so as to be movable in rotation, the support (32) being configured to be in a state in which it is movable in rotation about the axis of rotation of the driving wheel (21) and a stationary state in which it is held in position by a blocking member (33).

3. The display device (10) according to claim 2, wherein the transmission wheel (31) forms a satellite of the driven wheel (111) and the driving wheel (21) is formed by a ring gear including an internal toothing.

4. The display device (10) according to claim 3, wherein the driving wheel (21) and the driven wheel (111) are arranged coaxially.

5. The display device (10) according to claim 2, wherein the support (32) has two radial arms (320, 321), one of which carries the transmission wheel (31) and the other one is held by clamping in a notch in the structure (12) of the watch movement by the blocking member (33) when the support (32) is in the stationary state.

6. The display device (10) according to claim 5, wherein one of the arms (320) comprises an adjustment member (322), the actuation of which allows moving the support (32) when it is in the movable state.

7. The display device (10) according to claim 6, wherein the free end of the arm (320) carrying the transmission wheel has the adjustment member (322), the latter being formed by a notch.

8. The display device (10) according to claim 2, wherein the display (11) includes a roller movable in rotation and formed by two lateral flanges (112) between which are interposed flaps (113) movable in rotation respectively according to axes parallel to that one of the roller, one of the flanges (112) being kinematically linked to the driven wheel (111), the axis of rotation of the driving (21) and driven (111) wheels coinciding with that of the roller.

9. A watch movement comprising a structure (12) and a display device (10) according to claim 1.
